(19) United States
(12) Patent Application Publication
(10) Pub. No.: US 2009/0275313 A1
(43) Pub. Date: Nov. 5, 2009

(54) METHOD, A SYSTEM AND A COMPUTER PROGRAM PRODUCT FOR WAP BROWSING ANALYSIS IN ON AND OFF PORTAL DOMAINS

(76) Inventors: Avraham HALEVA, Rishon Lezion (IL); Ariel Fligler, Hod-Hasharon (IL); Carmit Sahar, Tel Aviv (IL)

Correspondence Address: Pearl Cohen Zedek Latzer, LLP, 1500 Broadway, 12th Floor, New York, NY, 10036, US

(21) Appl. No.: 12/359,642

(22) Filed: Jan. 26, 2009

Related U.S. Application Data
(60) Provisional application No. 61/023,216, filed on Jan. 24, 2008.

(51) Int. Cl. H04M 3/42

(52) U.S. Cl. 455/414.1

(57) ABSTRACT

A Method, a System and a Computer Program Product for WAP Browsing Analysis In On And Off Portal Domains.

### CROSS-REFERENCE TO RELATED APPLICATIONS

This application claims the benefit of U.S. Provisional Patent Application No. 61/023,216, filed on Jan. 24, 2008, which is incorporated in its entirety herein by reference.

### FIELD OF THE INVENTION

The invention relates to methods, systems, and computer program products for WAP Browsing Analysis In On And Off Portal Domains

### BACKGROUND OF THE INVENTION

With the advent of mobile technology, and mobile media some mobile operators are moving beyond the concept of a walled garden into the off portal realm. For years, users of many mobile operators have been confined to consume content provided by the operator in its content portal. As mobile handsets are more common and as more innovative services can be offered, many new content providers and aggregators are moving into the value chain offering customers content which is not necessarily associated with the mobile operator portal. Further, the mobile industry is now moving ahead into mobile advertising where users are being presented with advertisements while previewing mobile content or while doing some kind of contextual related activity like searching for a specific content. To keep up with the competition, mobile operators can't rely only on themselves for supplying interesting content, and thus their business models need to be adjusted to incorporate the usage of off-portal content and service providers.

For example, the following scenarios exemplify some emerging business models:
a. Participation in the advertisement value chain—content providers with high hit rates are seen as lucrative by ad agencies. As mobile users surf using the mobile operator infrastructure, many times paying only a flat rate for usage, operators want a stake in the ads revenue.
b. To be discovered by users, content providers some times are being linked and pointed to through the operator's portal top deck. The operator many times bill the providers based on the actual usage of those media assets.
c. Off portal billing—independent top content providers who serve many operators many times bill operators for allowing their customers to browse their site, again, in proportion to actual usage.

As the examples above show, the operator needs to be able to quantify the level of usage for a specific content provider's site in order to enable profitable business models. The challenge with this effort is that the operators systems lack the full information on users consumptions and the operator has no way to validate information coming from the content provider. Specifically, in WAP communication, operators need to rely on their Wap Gateways logs. Due to the WAP protocol structure, pages components do not come in a structure way but rather as a stream of objects embedded in the main root objects. Such objects can be media or text objects or even embedded pages. Further, as the user can interact with the flow by entering a new URL or pressing an embedded link, the stream can change in the middle to start serving a new page. Thus, the challenge stands to be how to reconstruct effectively and accurately users surfing by identifying the pages they surf to in off portal (namely, in sites that are not being served by the operator and thus no knowledge exists on their site structure).

The current invention includes a system for analysis of hyperlinked based traffic (such as web, mobile web) in off portal domains using a URL syntax analysis.

### SUMMARY OF THE INVENTION

A Method, a System and a Computer Program Product for WAP Browsing Analysis In On And Off Portal Domains.

### BRIEF DESCRIPTION OF THE DRAWINGS

The foregoing and other objects, features, and advantages of the present invention will become more apparent from the following detailed description when taken in conjunction with the accompanying drawings. In the drawings, similar reference characters denote similar elements throughout the different views, in which:

FIG. 1 illustrates a flow of the proposed algorithm, according to an embodiment of the invention; and

FIGS. 2, 3, and 4 illustrates data structures, according to several embodiments of the invention.

### DETAILED DESCRIPTION OF THE DRAWINGS

### Method

Specification of the proposed algorithm follows.

It is assumed that the algorithm has access to the WAP Gateway log where requests for objects can be found (whether root URLs or embedded objects).

Several ideas lead to the method presented. First, is that the operator does not always need information at the granularity of the single page. Billing by a page for a tier 1 operator would be an impossible endeavor. Thus, some level of aggregation is in place to allow the operator and the content provider to discuss usage in granularity that is higher than domain but lower than a single page. Further, techniques to identify a logical page (namely, that two pages that look differently due to personalization for example, are logically the same. For example, the entry page for an online merchant or ones bank account page) may incur high processing if their input would be too big. Thus, limiting the analysis to a set of pages may be beneficial. To make this effective, some technique to do this at a granularity higher than the domain level is required.

### A. Input Filtering

In the first filtering step, the algorithm filters the log file information to include only requests for page objects. These can be both root pages or embedded pages. The critical issue here is that the input for the algorithm at this stage strips the input data from embedded objects which are not links for page objects such as text/HTML or text/WML MIME types as examples.

In order to confront requests generated by robots, frames and occurrences where users hit links before the page fully loaded, page requests (page URL with the right MIME type) are also filtered using the following heuristic. The log (with only page URLs) is scanned and URLs are removed if their request time lag is less than 1 second from the previous page request response. This heuristic can be replaced with other rules based on the evolution of the environment (if new log entries based on new entities in the WAP habitat will be developed).

### B. Top-X List Filtering

At this stage the list of domains the algorithm will analyze is being generated using either of two ways:
a. Based on a given list that represents the operators interests (for example the top 100 sites that bill the operator for traffic)
b. By running an initial analysis on traffic at the domain level to generate a list of the top domains with traffic. For such analysis the granularity of specific pages or page types is not important. This can be done based on total pages, unique users, a ratio between them or any other measure the operator deems right. Further, this stage can be done using a sampling of the traffic and not the complete data set.

### C. URL Analysis

This is the main phase of the algorithm.
I. For each domain in the domain list the algorithm does the following:
   i. URL tokenization—the algorithm breaks the URL into its building blocks, or tokens. 3 types of tokens are available:
      1. Domain
      2. Path
      3. Parameters
   Each token is being associated with a level based in its order in the URL syntax and its type according to the following template example:
   Domain/[path level 1]/[path level 2]/[path level 3]/. . . /[parameter level 1] & [parameter level 1].
   In the example of www.cnn.com/news/sports/footbal/page id12 & Language=5 the following tokens are generated:
      www.cnn.com [DOMAIN, Level 1]
      news [PATH, Level 1]
      sports [PATH, Level 2]
      Europe [PATH, Level 3]
      Page id=12 [Parameters, Level 1]
      Language=5 [Parameters, Level 2]
   ii. Frequency calculation—the algorithm calculates for each token its frequencies within the domain at the level it belongs to. Thus ‘football’ in www.cnn.com/news/sports/footbal/index.html and www.cnn.com/sports/footbal/index.html are counted separately as they belong to a different URL level.
   iii. Threshold filtering—once frequencies have been calculated to all tokens, they are being compared to a domain specific threshold. This threshold is normalized within the domain and/or within the URL pattern, so it will suit better the distribution of pages within the domain and be sensitive enough to the appearance of pages with lower frequencies. The threshold designates the level of frequency of interest, so page families with lower frequencies at a certain token are not represented. If a token is not represented, it will be marked as ‘*’ in the list of page families. In the example of www.cnn.com/sports/footbal/index.html, if ‘football’ would not have passed the threshold, then the page family would be presented as www.cnn.com/sports/*/index.html.
II. Combining domains—this stage comes to combine together page families that belong to the same business entity where the URL syntax may change due to technical considerations such as load balancing or a daughter business entity.
This stage is a heuristic, that comes to augment known business information. It allows the operator to mine for missing ‘hits’ when it negotiates browsing statistics with an external party.
Two methods are being employed:
   i. Combining domains based on URL similarity—This is done based on syntax similarity of the domain part. For example, page families from www.cnn.com and weather.cnn.com will be merged and presented under www.cnn.com. The similarity can be defined using rules that dictate the common domain part or any kind of textual distance function.
   ii. Combining domains based on linkage analysis—This is done based on analyzing the traffic between page families. The algorithm constructs a graph where there is an edge from a page family A to page family B if a user traverse a link from A to B. the page families analyzed ere are the higher low granular ones usually at the level of the domain or one level lower (e.g. www.cnn.com/sports). Once session information is being analyzed for all users, the graph is analyzed to track relevant patterns. If a link exists between two domain different page families where an extensive traversing has been spotted above a certain threshold, then the two domains will be deemed as combined. For example, if 92% of the inbound sessions into espn.footbal.com comes from www.cnn.com the two domains will be deemed as belonging to www.cnn.com.
   iii. Usage of such links can be made on demand in case inconsistencies are found, or once being detected, be stored in a pre-define list of association to prevent the need top redetect this information again.

### D. Collecting Statistics

Once the analysis objects have been defined (the page families), the algorithm re-scans the log file to collect information on each page family. For each URL that the algorithm identifies, the algorithm collects information and aggregates it as part of the page family the page belongs to. The algorithm scans the log between URLs and associates the information with the previous URL (namely, it is assumed that embedded objects belong to the URL that comes before them). By URL we refer to MIME page objects such as text/HTML text/WML etc, or any other MME type that represents a page object.

Statistics that are been calculated include:
a. Hits—the number of times the page family has been requested
b. Error rates—the number of times errors have been received for a request. This can be both for the page as a whole (so, for example, the whole page could not be found) or for its embedded objects (so for example some images could not be found).
c. Other—any statistics that can be calculated using the contained information in the log. For example, the percentage of user agents of a certain kind that accessed that page family. The wealth of information here depends only on the available information contained within the files.

### E. Calibration and On Going

The algorithm can be run in two ways:
I. Every time frame (day, week, month etc.) run the algorithm on the whole period including historical data. This could result in huge amounts of data to be processed.
II. Run the data on a baseline data set (for example first 3 months) to generate the page families, and then update the information based on new information being collected for consecutive time frames (for example every consecutive month).
   Taking the second approach as a more viable one, performance wise, the algorithm acts as follows:
      I. In each consecutive time period, every page URL analyzed is being mapped to one of the existing page families. If a page family exists, the algorithm updates its statistics. In that respect, page families and token frequencies are being checked to see if their frequencies have not been changed to be below or above the frequency threshold.
      II. If a page is found which can't be mapped to an existing page family, it is being stored in the ‘Others’ page family. The size of the ‘others’ page family gives a sense to the accuracy of the current analysis.
      III. After the algorithm finishes running though the page links, it analyses the ‘others’ directory in the same way described above to extend the page families library with new patterns. This was, the analysis can stay up to date.
      As an option, sampling can be done by which only a subset of the data will be analyzed to generate up to date information on consumptions.

### F. Error Handling

It has been shown that sometimes web sites erroneously send non page items such as GIFs as page elements. As the algorithm takes advantage of large numbers phenomenon, such behaviors will be trapped by the algorithm statistical mechanisms. In any case, page elements where there is a question (for example, they are near in 0 time to another page element and due to low occurrence may be suspicious as non page) can be isolated in an error group. This group may be inspected from time to time by an automated crawler that will try to fetch the pages to examine if indeed they are a page or an error on behalf of the web site. A Longtail approach can be employed where only erroneous pages with high occurrence will be examined.

### G. Usage & Presentation

When the algorithm finishes (for a certain timeframe), it includes a list of page families where each is associated with some data. These can be presented using different methods:
I. As list of page families sorted alphabetically within a certain domain
II. As a hierarchy, where page families are aggregated by similarity in their pattern. For example, www.cnn.com/news/europe/sports/* and www.cnn.com/news/europe/economy/* will both belong to www.cnn.com/news/europe/. When a hierarchy is created, the algorithm aggregates the statistics at the level of the aggregating page family pattern (www.cnn.com/news/europe/ in the example).

The user can use filtering to further adjust the presentation like selecting a threshold of page family frequency to be presented etc. also, the user can select page families by their URL syntax, for example, page families with/News/in their tokens.

The following represents an example usage scenario for the algorithm's results:

1. As an example, lets assume that www.provider.com negotiates with operator MyMobile for access to its content by MyMobile users. The provider claims that 1 million pages have been accessed.

2. MyMobile will look at the report at www.provider.com and compare the hits number with the supplier number. In case some inconsistencies arise, the operator can use different page families as validation hooks to try and spot where the inconsistency comes from. For example, he can as the provider to supply hits information at the level of ‘www.provider.com/sports/footbal/europe’

3. Further, the operator can look at the linkage list between page families to spot that many links exist between www.provider.com and sports.provider.com and the missing hits can be associated with browsing at the later domain.

The ability to identify pages in browsing also amends itself to more complex analysis such a s session analysis in on portal browsing where the operator aims to find the most common browsing sessions. For this, frequencies are calculated for movement patterns between page families.

### Process Depiction

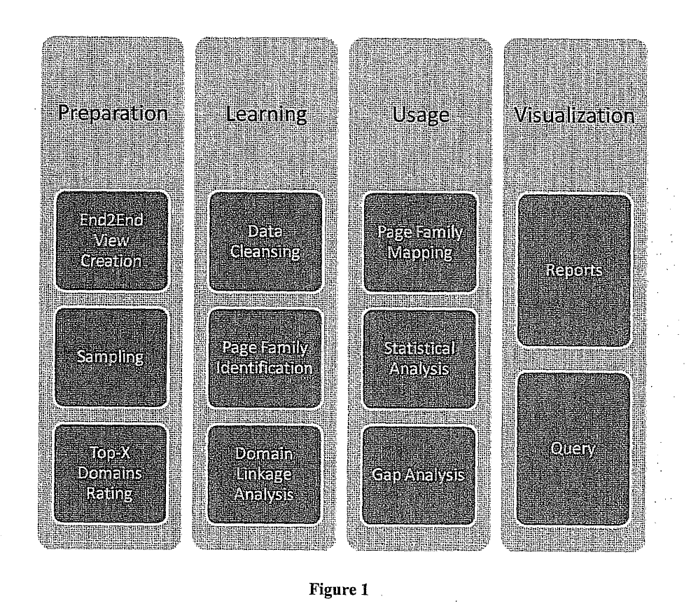

FIG. 1 illustrates a flow of the proposed algorithm, according to an embodiment of the invention. Flow moves from left to right and from top to bottom.

### Addendum—Time Based Web Page Reconstruction Algorithm

This algorithm can run as a pre-processing step before the main algorithm run, or as a refining phase once page families are identified. Further, this approach can be extended to support the full solution to the business problem this patent comes to solve.

Input to the algorithm—the log file arranged first by msisdn's and then by time.

Ideally, timing information would be provided with ms accuracy, but the algorithm can also manage with an accuracy of just seconds.

### The First Pass

During the first pass, the algorithm constructs the following data structures:

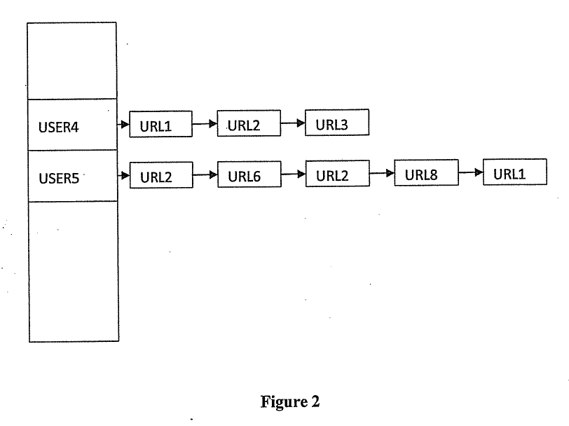

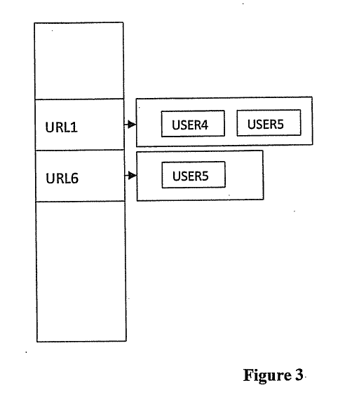

From every user to all the visited URLs ordered by time, e.g. as illustrated in FIG. 2.

From every URL to all the users who visited this URL:

It should be noted that all information in the URL address after the first “?” is currently dropped. This can be improved by searching for many users who visited the same URL

### The Second Pass

During the second pass, the algorithm picks out the URLs in order of decreasing frequency (i.e. most popular URL first).

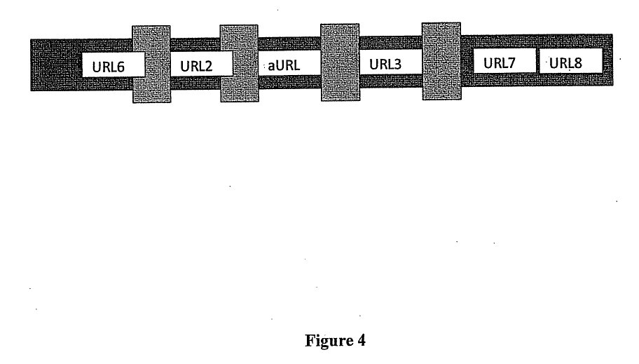

Referring to FIG. 4, for each of these URLs, which we call the “anchor URL” or aURL, we find the URLs in its neighborhood, defined as: URLs which are at most a (time) distance of X seconds from aURL (in the green region in the picture below), as well as a distance of Y seconds away from the previous URL which qualified to enter the neighborhood (see orange region in FIG. 4), then this URL will also be in the neighborhood. We shall denote it by nURL.

In the above example, all URLs are within X sec of aURL. URL2 and URL6 are comfortably within the Y seconds limit of the preceding URL, and are included in the neighborhood. URL3 just barely makes the cut. However, URL7 is not within Y sec of URL3 and will therefore not be included in aURL's neighborhood. URL8 will not even be considered, since there was a break in the neighborhood, between URL3 and URL7.

For each nURL, we record the following:
a. Δtmin—nURL's minimum distance to aURL, averaged over all aURL in whose neighborhood it appeared (aURL may appear for more than one user, and for each user in more than once).
b. σ(Δtmin)—The standard deviation of the minimum distance—if nURL is truly in aURL's neighborhood, then the standard deviation will be small: nURL will be automatically loaded right after aURL. If however nURL and aURL are on different pages (but many users surf to nURL after visiting aURL, and doing simple analyses we would wrongly conclude that they are on the same page), then due to the fact that different people browse aURL for a different length of time, the standard deviation would be large.
c. Δnmin—For each nURL that passes the constraints to be in aURL's neighborhood, this is the distance in URL's between aURL and nURL (i.e. the number of URL's in the time-sorted log file between nURL and aURL), averaged over all appearances of nURL in aURL's neighborhood in the log file.
d. σ(Δnmin)—The standard deviation of the minimum distance in pages.
e. N(aURL:nURL)—The number of times nURL appeared in the neighborhood (if it truly belongs to the same page as aURL, then this value will be close to the number of appearances of aURL)
f. N(nURL)—The total number of times nURL appeared in the entire log file (if it belongs to the same page as aURL, then this will be very close to the number of times nURL appears in aURL's neighborhood).

We summarize in a table the expected values for the above variables in 2 cases: when nURL truly belongs in the same physical page as aURL (Case 1), and when it belongs in a different page (Case 2). These values are for the average case, and therefore only applicable for a large population (i.e. for popular URL's). Individual behavior patterns vary greatly.

| | Case 1 (same | Case 2 (different |
|---|---|---|
| Parameter | page) | pages) |
| Δtₘᵢₙ | Small (<5 sec) | >20 sec |
| σ(Δtₘᵢₙ) | Small (<Δtₘᵢₙ) | >Δtₘᵢₙ |
| Δnₘᵢₙ | Small (<10, when images etc are | Large |
| | also taken into account) | |
| σ(Δnₘᵢₙ) | Close to 0 (variations exist since | Large (ditto) |
| | URLs are not always loaded in the | |
| | same order in different browsers) | |
| N(aURL: | Should be close to 1, unless the | Very small (<<0.01) |
| nURL)/ | physical page is personalized, and | |
| N(aURL) | only part of the users get nURL. | |
| | (But a consistenly small Δtₘᵢₙ | |
| | should be indication enough) | |

The algorithm is fine tuned using a test sample (where it is known which URLs belong in the same page). This gives a collection of association rules (or any other data mining algorithm such as decision trees, neural nets, etc. . . . ) for the above parameters: a certain set of parameters values would indicate that 2 URLs are on the same page, whereas a different region in the parameter space would indicate that the URLs belong on different pages.

The present invention can be practiced by employing conventional tools, methodology and components. Accordingly, the details of such tools, component and methodology are not set forth herein in detail. In the previous descriptions, numerous specific details are set forth, in order to provide a thorough understanding of the present invention. However, it should be recognized that the present invention might be practiced without resorting to the details specifically set forth.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

1. (canceled)

2. A method as substantially described in the specification.

3. (canceled)

4. A system as substantially described in the specification.

5. (canceled)

6. A computer program product as substantially described in the specification.
